(19) United States
(12) Patent Application Publication
(10) Pub. No.: US 2007/0116463 A1
(43) Pub. Date: May 24, 2007

(54) Bi-directional optical cross coupler

(75) Inventors: Sung-Bum Park, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/592,638

(22) Filed: Nov. 3, 2006

(30) Foreign Application Priority Data
Nov. 21, 2005 (KR) 2005-111249

(51) Int. Cl. H04J 14/00

(52) U.S. Cl. 398/50

(57) ABSTRACT

An optical cross coupler for connecting at least two different optical communication networks includes: first to fourth circulators, each circulator comprising first to fourth ports, the first port connected to a relevant communication network; a first line connecting the second port of the first circulator and the fourth port of the second circulator; a second line connecting the fourth port of the first circulator and the second port of the second circulator; a third line connecting the second port of the third circulator and the fourth port of the fourth circulator; a fourth line connecting the fourth port of the third circulator and the second port of the fourth circulator; a fifth line connecting the third port of the first circulator and the third port of the fourth circulator; and a sixth line connecting the third port of the second circulator and the third port of the third circulator.

### CLAIM OF PRIORITY

This application claims priority under 35 U.S.C. § 119 to an application entitled “Bi-directional Optical Cross Coupler,” filed in the Korean Intellectual Property Office on Nov. 21, 2005 and assigned Serial No. 2005-111249, the contents of which are incorporated herein by reference.

### BACKGROUND OF THE INVENTION

1. Field of the Invention

The present invention relates generally to a wavelength division multiplexing (WDM) optical communication network, and in particular, to a metro access WDM optical communication network including an optical cross coupler for cross-connecting two different communication networks.

2. Description of the Related Art

A conventional optical cross coupler includes a plurality of passive components and wavelength selectors for exchanging optical signals by connecting different wavelength division multiplexing (WDM) optical communication networks to each other. The conventional optical cross coupler can include circulators for routing optical signals, an optical splitter, and wavelength selectors, such as an optical fiber grid, for selecting a wavelength.

An example of the conventional optical cross coupler is disclosed in U.S. Pat. No. 6,288,812 (Sep. 11, 2001) invented by Gary et al. entitled, “Bidirectional WDM Optical Communication Network with Optical Bridge between Bidirectional Optical Waveguides.” Briefly, the optical cross coupler disclosed in U.S. Pat. No. 6,288,812 includes 16 circulators and 6 wavelength selectors, and it can transmit/receive optical signals having a total of four different wavelengths by connecting two different optical communication networks to each other.

However, since the conventional optical cross coupler uses circulators and wavelength selectors in which an optical loss is high, an optical loss of more than 8 dB per transmission/reception channel occurs. In addition, since the conventional optical cross coupler includes a plurality of components, the cost is high.

### SUMMARY OF THE INVENTION

An object of the present invention is to substantially solve at least the above problems and/or disadvantages and to provide at least the advantages below. Accordingly, an object of the present invention is to provide an economical optical cross coupler composed of a fewer number of components for minimizing an optical loss.

According to one aspect of the present invention, there is provided an optical cross coupler for connecting more than two different optical communication networks to each other which includes: first to fourth circulators, each circulator comprising first to fourth ports, the first port coupled to a relevant communication network; a first line coupling the second port of the first circulator and the fourth port of the second circulator; a second line coupling the fourth port of the first circulator and the second port of the second circulator; a third line coupling the second port of the third circulator and the fourth port of the fourth circulator; a fourth line coupling the fourth port of the third circulator and the second port of the fourth circulator; a fifth line coupling the third port of the first circulator and the third port of the fourth circulator; and a sixth line coupling the third port of the second circulator and the third port of the third circulator.

### BRIEF DESCRIPTION OF THE DRAWINGS

FIG. 1 is a configuration of an optical cross coupler according to an embodiment of the present invention.

### DETAILED DESCRIPTION OF THE INVENTION

Embodiments of the present invention will be described herein below with reference to the accompanying drawings. For the purposes of clarity and simplicity, well-known functions or constructions are not described in detail as they would obscure the invention in unnecessary detail.

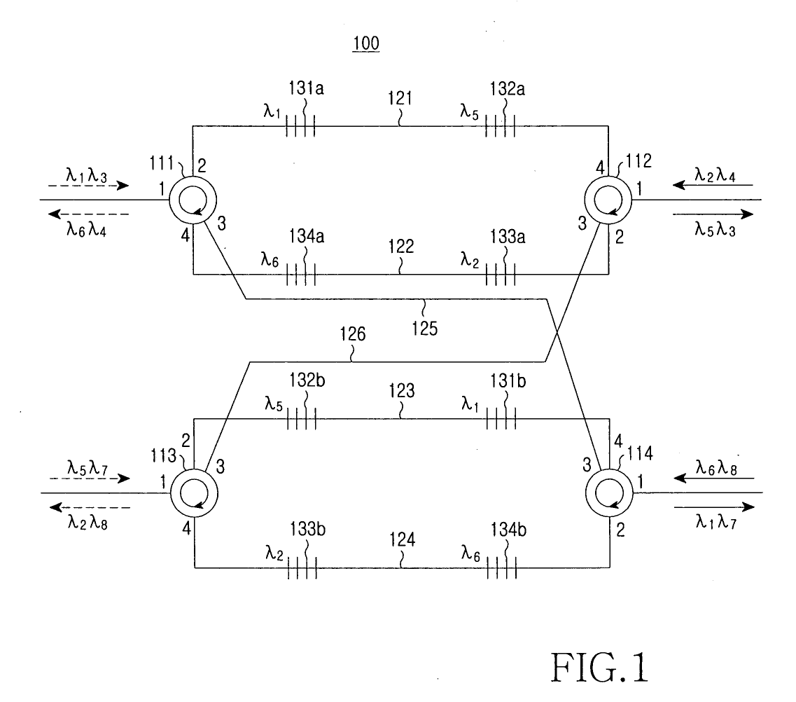

FIG. 1 is a configuration of an optical cross coupler 100 according to an embodiment of the present invention. As shown, the optical cross coupler 100 is configured for connecting more than two different optical communication networks to each other and includes first to fourth circulators 111, 112, 113, and 114, first to sixth optical lines 121, 122, 123, 124, 125, and 126, and first and second wavelength selectors 131a, 131b, 132a, 132b, 133a, 133b, 134a, and 134b disposed in the first to fourth lines 121, 122, 123, and 124.

Each of the first to fourth circulators 111, 112, 113, and 114 includes first to fourth ports, wherein the first and second circulators 111 and 112 are located on a first network and the third and fourth circulators 113 and 114 are located on a second network. The first network transmits and receives a first optical signal, which is composed of first and third channels λ₁ and λ₃, and a second optical signal, which is composed of second and fourth channels λ₂ and λ₄, and the second network transmits and receives a third optical signal, which is composed of fifth and seventh channels λ₅ and λ₇, and a fourth optical signal, which is composed of sixth and eighth channels λ₆ and λ₈.

The second port of the first circulator 111 and the fourth port of the second circulator 112 are connected to each other by the first line 121 in which the first wavelength selectors 131a and 132a for respectively reflecting the first channel λ₁ and the fifth channel λ₅ are arranged in series. That is, the first optical signal input through the first port of the first circulator 111 is output through the second port of the first circulator 111, and the first channel λ₁ of the first optical signal output through the second port of the first circulator 111 is reflected to the second port of the first circulator 111 by the first wavelength selector 131a and output through the third port of the first circulator 111. The third port of the first circulator 111 is connected to the third port of the fourth circulator 114 by the fifth line 125, thus, the first channel λ₁ is input to the fourth circulator 114. The third channel λ₃ passes through the first wavelength selectors 131a and 132a located in the first line 121 and is output through the first port of the second circulator 112.

The fourth port of the first circulator 111 and the second port of the second circulator 112 are connected to each other by the second line 122 in which the second wavelength selectors 133a and 134a for respectively reflecting the second channel λ₂ and the sixth channel λ₆ are arranged in series. That is, the second optical signal input through the first port of the second circulator 112 is output through the second port of the second circulator 112, and the second channel λ₂ of the second optical signal output through the second port of the second circulator 112 is reflected to the second port of the second circulator 112 by the second wavelength selector 133a and output through the third port of the second circulator 112. The third port of the second circulator 112 is connected to the third port of the third circulator 113 by the sixth line 126, and thus, the second channel λ₂ is input to the third circulator 113. The fourth channel λ₄ passes through the first wavelength selectors 133a and 134a located in the second line 122 and is output through the first port of the first circulator 111.

The second port of the third circulator 113 and the fourth port of the fourth circulator 114 are connected to each other by the third line 123 in which the first wavelength selectors 131b and 132b for respectively reflecting the first channel λ₁ and the fifth channel λ₅ are arranged in series. The fourth port of the third circulator 113 and the second port of the fourth circulator 114 are connected to each other by the fourth line 124 in which the second wavelength selectors 133b and 134b for respectively reflecting the second channel λ₂ and the sixth channel λ₆ are arranged in series.

The third circulator 113 outputs the third optical signal, which is input through the first port, to the fourth circulator 114 through the third line 123, and the fifth channel λ₅ of the output third optical signal is reflected to the second port of the third circulator 113 by the first wavelength selector 132b. The fifth channel λ₅ reflected to the second port of the third circulator 113 is input to the third port of the second circulator 112 through the sixth line 126 and output through the fourth port of the second circulator 112. The fifth channel λ₅ output through the fourth port of the second circulator 112 is reflected by the first wavelength selector 132a and output to the first network through the first port of the second circulator 112. The second channel λ₂ input to the third port of the third circulator 113 through the sixth line 126 is output through the fourth port of the third circulator 113, reflected by the second wavelength selector 133b, and output to the second network through the first port of the third circulator 113. The seventh channel λ₇ passes through the first wavelength selectors 131b and 132b located in the third line 123 and is output through the first port of the fourth circulator 114.

The fourth circulator 114 outputs the fourth optical signal, which is input through the first port, to the third circulator 113 through the fourth line 124, and the sixth channel λ₆ of the output fourth optical signal is reflected to the second port of the fourth circulator 114 by the second wavelength selector 134b. The sixth channel λ₆ reflected to the second port of the fourth circulator 114 is input to the third port of the first circulator 111 through the fifth line 125 and output through the fourth port of the first circulator 111. The sixth channel λ₆ output through the fourth port of the first circulator 111 is reflected to the fourth port of the first circulator 111 by the second wavelength selector 134a and output to the first network through the first port of the first circulator 111. The eighth channel λ₈ passes through the second wavelength selectors 133b and 134b located in the fourth line 124 and is output through the first port of the third circulator 113.

The fourth circulator 114 outputs the first channel λ₁, which is input through the fifth line 125, through the fourth port thereof. The first channel λ₁ output through the fourth port of the fourth circulator 114 is reflected to the fourth port of the fourth circulator 114 by the first wavelength selector 131b and output to the second network through the first port of the fourth circulator 114.

The number of the first and second wavelength selectors 131a, 131b, 132a, 132b, 133a, 133b, 134a, and 134b can be more than two according to the number of channels to be crossed to another network and be variously arranged according to wavelengths of the channels to be crossed. Bragg gratings can be used for the first and second wavelength selectors 131a, 131b, 132a, 132b, 133a, 133b, 134a, and 134b. That is, the first wavelength selectors 131a, 131b, 132a, and 132b and the second wavelength selectors 133a, 133b, 134a, and 134b can be implemented by connecting at least two Bragg gratings, which can selectively reflect light having different wavelengths, in series in each line.

However, as in the embodiment of the present invention, the arrangement of the wavelength selectors 131a, 131b, 132a, 132b, 133a, 133b, 134a, and 134b can be implemented by configuring the first wavelength selectors 131a, 131b, 132a, and 132b located in the first and third lines 121 and 123 to reflect channels having the same wavelengths and configuring the second wavelength selectors 133a, 133b, 134a, and 134b to reflect channels having the same wavelengths.

As described above, according to the embodiment of the present invention, an optical cross coupler can cross-connect a plurality of channels to different networks while minimizing the number of optical components. Thus, effective network cross coupling can be achieved with low cost.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An optical cross coupler for coupling at least two different optical communication networks, comprising:
first to fourth circulators, each circulator comprising first to fourth ports, the first port coupled to a relevant communication network;
a first line coupling the second port of the first circulator and the fourth port of the second circulator;
a second line coupling the fourth port of the first circulator and the second port of the second circulator;
a third line coupling the second port of the third circulator and the fourth port of the fourth circulator;
a fourth line coupling the fourth port of the third circulator and the second port of the fourth circulator;
a fifth line coupling the third port of the first circulator and the third port of the fourth circulator; and
a sixth line coupling the third port of the second circulator and the third port of the third circulator.

2. The optical cross coupler of claim 1, further comprising:
first wavelength selectors disposed in the first and third lines; and
second wavelength selectors disposed in the second and fourth lines.

3. The optical cross coupler of claim 2, wherein the first and second wavelength selectors correspond to the number of wavelengths to be exchanged and coupled in series.

4. The optical cross coupler of claim 2, wherein the first or second wavelength selector comprises Bragg gratings.

5. The optical cross coupler of claim 4, wherein the first wavelength selectors are implemented by coupling, in series, at least two Bragg gratings for selectively reflecting light having different wavelengths.

6. The optical cross coupler of claim 4, wherein the second wavelength selectors are implemented by coupling, in series, at least two Bragg gratings for selectively reflecting light having different wavelengths.

7. An optical cross coupler comprising:
at least first pair of first and second circulators and at least second pair of third and fourth circulators coupled to at least two different optical communication networks, each circulator comprising a plurality of ports,
a plurality of first optical lines coupling the pairs of the circulars;
a second optical line coupling the first circulator and the fourth circulator; and
a third optical line coupling the second circulator and the third circulator.

8. The optical cross coupler of claim 7, further comprising:
a plurality of wavelength selectors disposed in the first, second, and third optical lines.

9. The optical cross coupler of claim 8, wherein the plurality of wavelength selectors comprises Bragg gratings.

10. The optical cross coupler of claim 9, wherein each of the plurality of wavelength selectors is implemented by coupling, in series, at least two Bragg gratings for selectively reflecting light having different wavelengths.
